(19) United States
(12) Patent Application Publication
(10) Pub. No.: US 2011/0320473 A1
(43) Pub. Date: Dec. 29, 2011

(54) DYNAMIC DETERMINATION OF MIGRATION DATA

(76) Inventors: David Desmond, Santa Clara, CA (US); Steven Cento, Cupertino, CA (US); Jack Matthew, San Francisco, CA (US)

(21) Appl. No.: 12/822,127

(22) Filed: Jun. 23, 2010

(51) Int. Cl. G06F 17/30

(52) U.S. Cl. 707/769; 707/E17.014

(57) ABSTRACT

A method and apparatus for the dynamic determination of migration data is described herein. In one embodiment, a process can be provided to search user data in a first system for migration data without requiring user interaction. The search of user data can be based on a blacklist. The blacklist can include one or more folders which should not be searched for migration data or one or more files which should not be included in the migration data. A search of system data for migration data can be performed without requiring user interaction. The search of system data can be based on a whitelist. The whitelist can include one or more file types.

### FIELD OF THE INVENTION

The field of invention can relate generally to computing systems, and, more specifically, to dynamic determination of migration data.

### BACKGROUND

Data may exist on a first system which is desirable to migrate to a second system. For example, when a user purchases or otherwise obtains a new data processing system, the user will often want to move or migrate the data on the older system (e.g., the first system) to a newer system (e.g., the second system). However, portions of data on the first system may not be desirable to migrate to the second system, such as data (e.g., operating system files, etc.) which is specific to the first system. Furthermore, a portion of the data may be proprietary to the first system and should not be migrated to the second system. Data associated with a user may be desirable to migrate but may not exist in folders associated with the user. For example, users often store their files outside of their user or home folders.

### SUMMARY OF THE DESCRIPTION

Mechanisms for dynamic determination of migration data, when, for example, a user is replacing an older system with a newer system, are described herein. In one embodiment, a process can be provided to search user data in a first system (e.g., the older system) for migration data, without requiring user interaction, based on a blacklist. The blacklist can comprise one or more folders which should not be searched for migration data or one or more files which should not be included in the migration data. The process can further search system data in the first system for migration data, without requiring user interaction, based on a whitelist. The whitelist can comprise one or more file types or one or more extensions. The whitelist, in one embodiment, can be used to search for files of types specified in locations that are outside of folders designated for a user (such as User's folders or “home” folders, set up by a computer or other data processing system when a computer is first set up), but not within folders that are specified in the blacklist. The blacklist can be used to exclude files from data to be migrated and the whitelist can be used to include files to be migrated from one system to another system. Systems, methods, and machine readable storage media which perform or implement one or more embodiments are also described.

Other features of the present invention will be apparent from the accompanying drawings and from the detailed description which follows.

### BRIEF DESCRIPTION OF THE DRAWINGS

The present invention is illustrated by way of example and not limited in the figures of the accompanying drawings, in which like references indicate similar elements and in which:

FIG. 1 illustrates an exemplary system architecture including multiple computer systems connected over a network in which embodiments of the present invention may operate;

FIG. 2 illustrates a block diagram of an exemplary computer system in which embodiments of the present invention may operate;

FIG. 3 illustrates an exemplary memory in accordance with FIG. 2;

FIG. 4 illustrates an exemplary whitelist in accordance with embodiments of the present invention;

FIG. 5 illustrates an exemplary blacklist in accordance with embodiments of the present invention;

FIG. 6 illustrates a flow diagram of a dynamic determination of migration data method in accordance with embodiments of the present invention;

FIG. 7 illustrates a flow diagram of an alternate dynamic determination of migration data method in accordance with embodiments of the present invention; and

FIG. 8 illustrates a flow diagram of a network connection method in accordance with embodiments of the present invention

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

Migration data can be dynamically determined to migrate from a first system to a second system. Migration data can include data which is to be migrated from a first system to a second system, and may also include files or folders. In one embodiment, dynamic determination of migration data can search user data in the first system based on a blacklist. The blacklist can contain folders which should not be searched because they are hidden or because they are specific to the first system, such as system folders or application folders that support applications for the first system. The blacklist can also contain a list of file types that should not be migrated and can also contain a list of file extensions that should not be migrated, such as system files or executable files. If a file type of a file matches one of the file types or a file extension of a file matches one of the extensions listed in the blacklist, the file may not be included in the migration data.

The dynamic determination of data can further search system data based on a whitelist. The whitelist can contain a list of file types or file extensions which are typically associated with user data or in locations outside of a user's “user” folder or “home” folder for the user. In one embodiment, a user's “user” folder can be a folder that is created by the user to store data created by or saved by the user, and may include text documents, music, pictures, videos, etc. created by or saved by the user. In one embodiment, a user's “home” folder can be a folder that is created by or saved by the user, and may include text documents, music, pictures, videos, etc. created by or saved by the user. In this embodiment, the user's “home” folder can be the highest level folder in a hierarchical file system which belongs to the user. User data can include data which is created by or saved by a user, as opposed to data which is created by or saved by a system. Although these files are not typically located in the system data of a system, a user or a program may have inadvertently placed those files in the system data. It can be desirable to include these files in the migration data. Therefore, any files whose file type or file extension match the file types or file extensions listed in the whitelist can be included in the migration data.

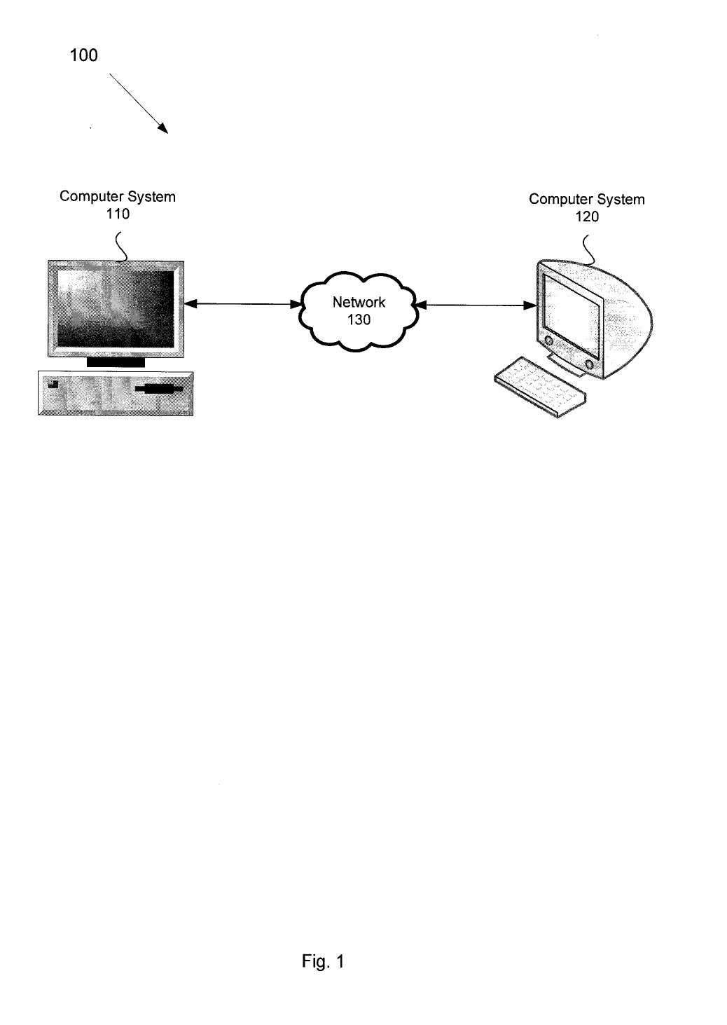

FIG. 1 shows a system architecture 100 in which the dynamic determination of migration data described above may be performed. System architecture 100 includes computer system 110 and computer system 120. Computer system 110 and computer system 120 may communicate with each other via network 130. In one embodiment, computer system 110 may contain a first operating system. In one embodiment, computer system 120 may contain a second operating system which is different than the first operating system in computer system 110. Data to be migrated from computer system 110 may be migrated to computer system 120 via network 130. In one embodiment, network 130 may be a public network (e.g., Internet) or a private network (e.g., local area network (LAN)).

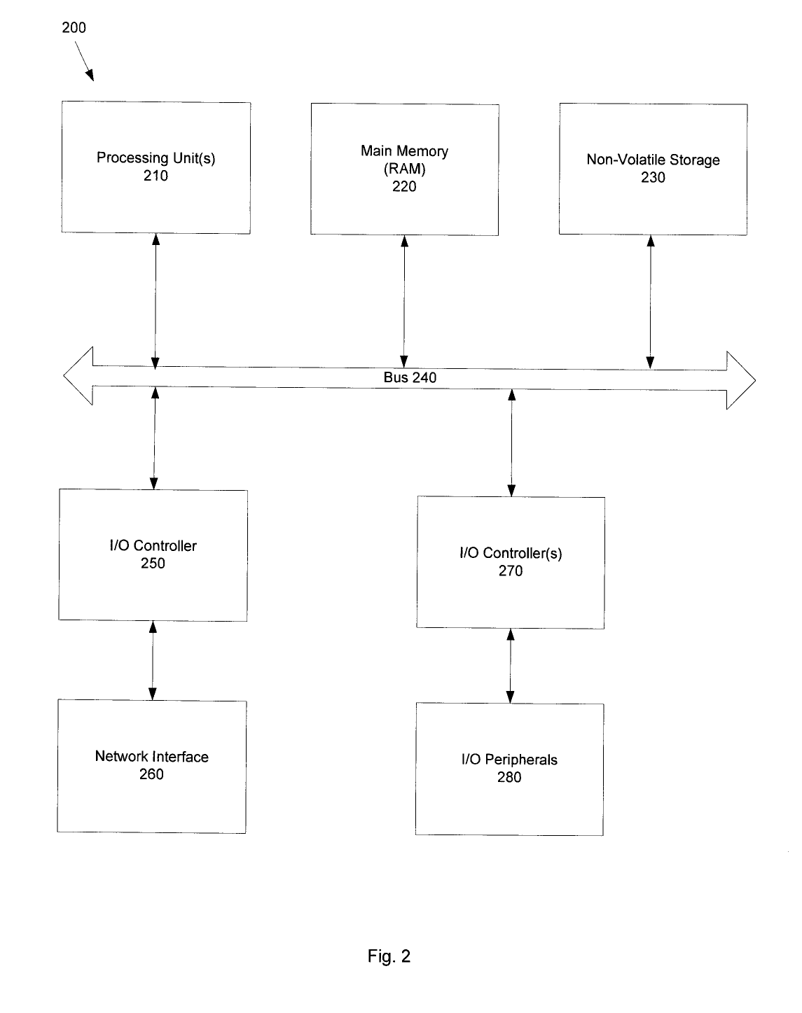

FIG. 2 is a block diagram of an exemplary computer system in which embodiments of the present invention may operate. Computer system 200 includes processing unit(s) 210, main memory (RAM) 220, non-volatile storage 230, bus 240, I/O controller 250, network interface 260, I/O controller 270, and I/O peripherals 280.

Main memory 220 encompasses all volatile or non-volatile storage media, such as dynamic random access memory (DRAM), static RAM (SRAM), or flash memory. Main memory 220 includes storage locations that are addressable by the processing unit(s) 210 for storing computer program code and data structures for dynamic determination of migration data. Such computer program code and data structures also may be stored in non-volatile storage 230. Non-volatile storage 230 includes all non-volatile storage media, such as any type of disk including floppy disks, optical disks such as CDs, DVDs and BDs (Blu-ray Disks), and magnetic-optical disks, magnetic or optical cards, or any type of media, and may be loaded onto the main memory 220. Those skilled in the art will immediately recognize that the term “computer-readable storage medium” or “machine readable storage medium” includes any type of volatile or non-volatile storage device that is accessible by a processor (including main memory 220 and non-volatile storage 230).

Processing unit(s) 210 is coupled to main memory 220 and non-volatile storage 230 through bus 240. Processing unit(s) 210 includes processing elements and/or logic circuitry configured to execute the computer program code and manipulate the data structures. It will be apparent to those skilled in the art that other processing and memory means, including various computer readable storage media, may be used for storing and executing computer program code pertaining to dynamic determination of migration data.

Processing unit(s) 210 can retrieve instructions from main memory 220 and non-volatile storage 230 via bus 240 and execute the instructions to perform operations described below. Bus 240 is coupled to I/O controller 250. I/O controller 250 is also coupled to network interface 260. Network interface 260 can connect to a network to migrate dynamically determined migration data.

Bus 240 is further coupled to I/O controller(s) 270. I/O controller(s) 270 are coupled to I/O peripherals 280, which may be mice, keyboards, modems, disk drives, optical drives, printers and other devices which are well known in the art.

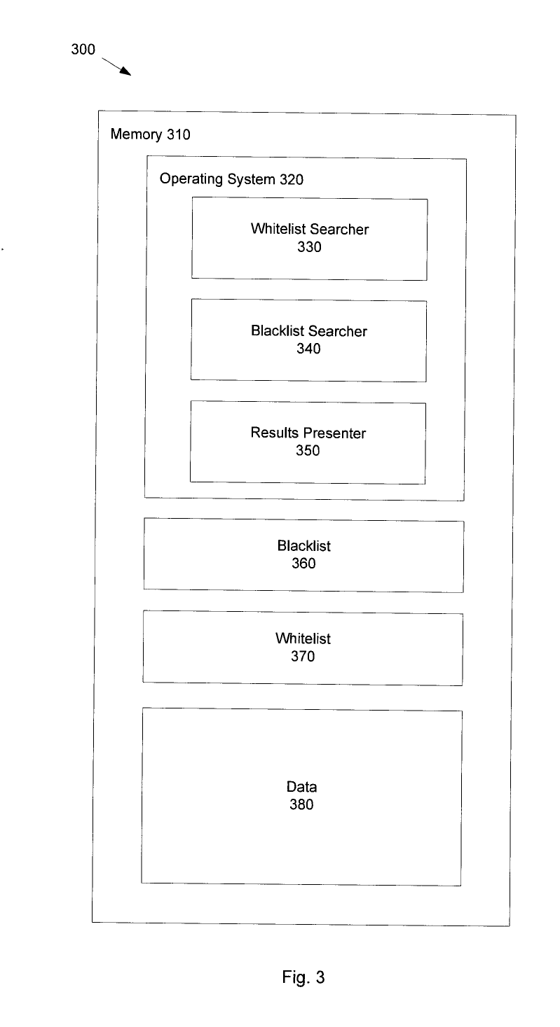

FIG. 3 illustrates an exemplary main memory 220 of FIG. 2. Referring to FIG. 3, memory 310 contains operating system 320, blacklist 360, whitelist 370, and data 380. Within operating system 320, there is whitelist searcher 330, blacklist searcher 340, and results presenter 350. In other embodiments, the software components 330, 340, and 350 can be separate from and not part of an operating system. Although memory 310 has been shown as a single memory, this is just one illustrative embodiment. In alternate embodiments, memory 310 can be split into more than one memory.

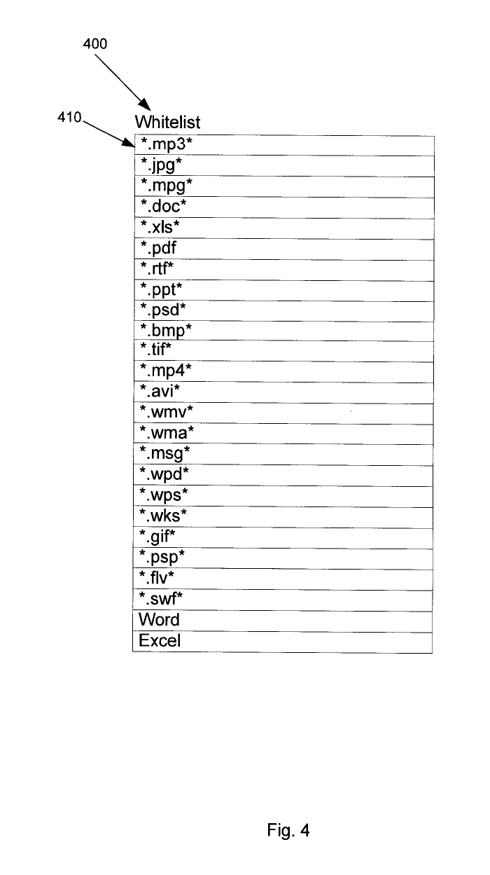

Whitelist searcher 330 can search data 380 based on a whitelist. An exemplary whitelist is described below in conjunction with FIG. 4. In one embodiment, the whitelist used to perform the search can be whitelist 370 located in memory 310. In an alternate embodiment, the whitelist can be located in operating system 320. In another alternate embodiment, whitelist searcher 330 can determine if a network is available. In this embodiment, if a network is available, whitelist searcher 330 can download the whitelist over the network.

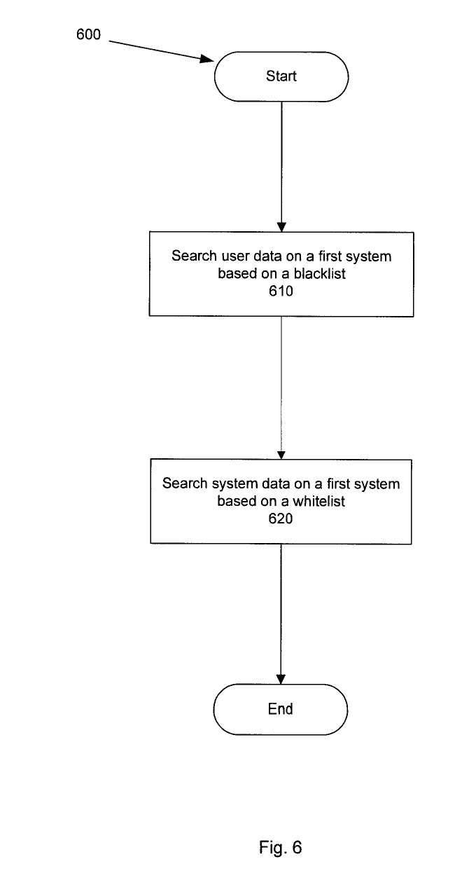

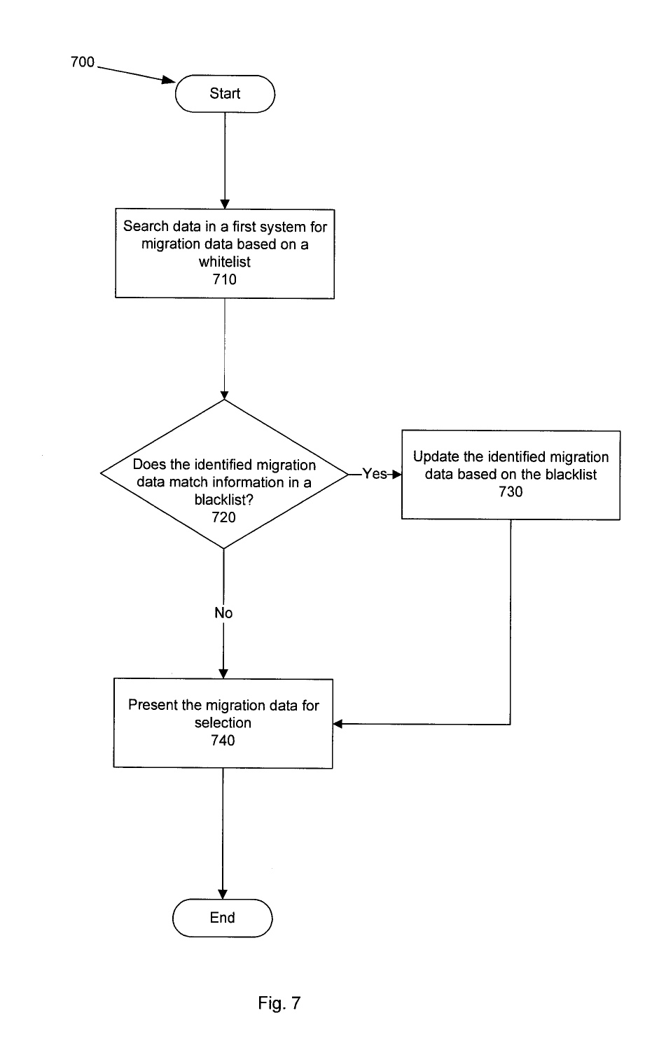

In one embodiment, whitelist searcher 330 can perform the search based on the whitelist without requiring user interaction. In one embodiment, the whitelist can identify one or more file types or file extensions. In one embodiment, whitelist searcher 330 can search data 380 in its entirety for files whose file types match a file type listed in the whitelist or files whose file extensions match a file extension identified in the whitelist. Searching data on a first system in its entirety is described below in conjunction with FIG. 7. In an alternate embodiment, whitelist searcher 330 can search the portion of data 380 which corresponds to system data of the system for files whose file types are listed in the whitelist or files whose file extensions match a file extension identified in the whitelist. Searching system data on a first system is described below in conjunction with FIG. 6. In this embodiment, a file identified based on the whitelist may correspond to user data that was saved within the first system's system data or otherwise outside of a user's “user” folder or “home” folder. It may be desirable to include the identified file(s) in migration data to be migrated to a second system. In one embodiment, once the migration data has been identified, whitelist searcher 330 can send the migration data to blacklist searcher 340. In an alternate embodiment, once the migration data has been identified, whitelist searcher 330 can send the migration data to results presenter 350.

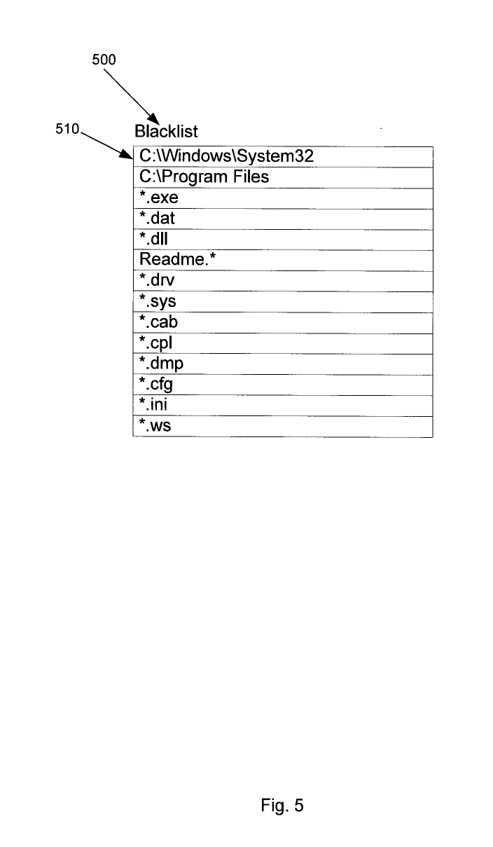

Blacklist searcher 340 can search data 380 based on a blacklist. An exemplary whitelist is described below in conjunction with FIG. 5. In one embodiment, the blacklist is blacklist 360 located in memory 310. In an alternate embodiment, the blacklist can be located in operating system 320. In another alternate embodiment, blacklist searcher 330 can determine if a network is available. In this embodiment, if a network is available, blacklist searcher 330 can download the blacklist over the network.

In one embodiment, blacklist searcher 340 can perform the search based on the blacklist without requiring user interaction. In one embodiment, the blacklist can identify one or more folders which may not be searched for migration data. In one embodiment, the blacklist can identify one or more file types or one or more file extensions. In one embodiment, any files whose file types match a file type identified in the blacklist or any files whose file extensions match a file extension identified in the blacklist may not be included in the migration data. In one embodiment, blacklist searcher 340 can search data 380 in its entirety for migration data based on the blacklist. In an alternate embodiment, blacklist searcher 340 can search a portion of data 380 which corresponds to user data of the system for migration data based on the blacklist. In another alternate embodiment, blacklist searcher 340 can search the migration data received from whitelist searcher 330 to update the migration data based on the blacklist. In this embodiment, the identified migration data can be updated such that any portion of identified migration data whose file type matches a file type listed in the blacklist or any portion of identified migration data whose file extension matches a file extension listed in the blacklist is removed. In this embodiment, the removed portion of the migration data can include system data or files which are undesirable to migrate to a second system. Blacklist searcher 340 can send the migration data to results presenter 350.

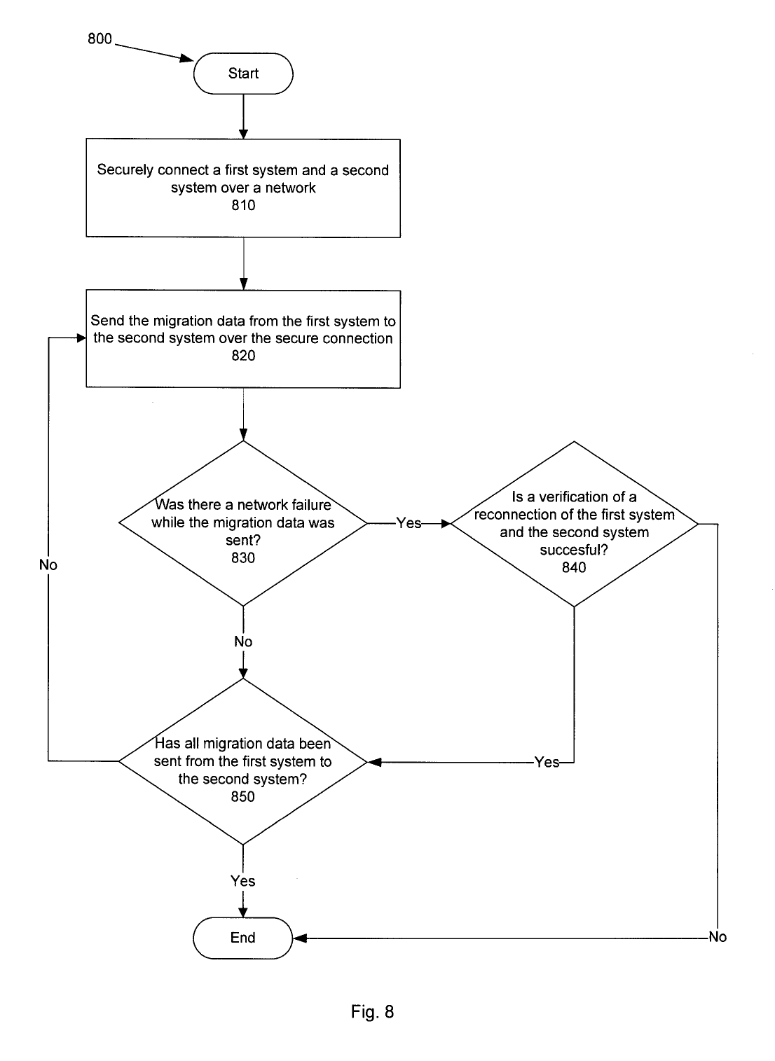

Results presenter 350 presents the migration data for selection. In one embodiment, results presenter 350 can present the migration data as a list of folders and files. In one embodiment, the list of folders presented can include a tab that can be clicked in order to list one or more files contained within the folder. In one embodiment, results presenter 350 can present the results of the migration data to a user. In this embodiment, the user can select a portion of the migration data to migrate from a first system to a second system. In one embodiment, upon a user's selection of a portion of the migration data, results presenter 350 can connect the first system to the second system over a network connection and migrate the selected portion of the migration data to the second system. The establishing the network connection and migration of data from the first system to the second system is described below in conjunction with FIG. 8.

FIG. 4 illustrates an exemplary whitelist in accordance with embodiments of the present invention. Referring to FIG. 4, whitelist 400 includes entries 410. Entries 410 include file types or file extensions which can be included in migration data from a first system to a second system. Entries 410 can include file extensions *.mp3*, *.jpg*, *.mpg*, *.doc*, *.xls*, *.pdf, *.rtf*, *.ppt*, *.psd*, *.bmp*, *.tif*, *.mp4*, *.avi*, *.wmv*, *.wma*, *.msg*, *.wpd*, *.wps*, *.wks*, *.gif*, *.psp*, *.flv*, *.swf* and file types of the applications known as Word and Excel. A search of all data in a first system based on whitelist 400 would result in migration data which includes all files in the first system which have the file extensions *.mp3*, *.jpg*, *.mpg*, *.doc*, *.xls*, *.pdf, *.rtf*, *.ppt*, *.psd*, *.bmp*, *.tif*, *.mp4*, *.avi*, *.wmv*, *.wma*, *.msg*, *.wpd*, *.wps*, *.wks*, *.gif*, *.psp*, *.flv*, *.swf*, all Word files, and all Excel files. Performing a searched based on a whitelist is described below in conjunction with FIG. 6 and FIG. 7, and this search can be performed, in one embodiment, entirely outside of folders designated in the blacklist, or, in an alternative embodiment, within the folders designated in the blacklist.

FIG. 5 illustrates an exemplary blacklist in accordance with embodiments of the present invention. Referring to FIG. 5, blacklist 500 includes entries 510. Entries 510 can include folders, file types, or file extensions which may not be included in migration data from a first system to a second system. In one embodiment, entries 510 include folders C:\Windows\System32 and C:\Program Files and file extensions *.exe, *.dat, *.dll, Readme.*, *.drv, *.sys, *.cab, *.cpl, *.dmp, *.cfg, *.ini, and *.ws. In this embodiment, a search of data in a first system based on blacklist 500 would exclude from migration data folders C:\Windows\System32 and C:\Program Files, any files contained in the C:\Windows\System32 and CAProgram Files folders, any files matching Readme*, as well as any files in the first system which have the file extensions *.exe, *.dat, *.dll, *.drv, *.sys, *.cab, *.cpl, *.dmp, *.cfg, *.ini, and *.ws. Performing a searched based on a blacklist is described below in conjunction with FIG. 6 and FIG. 7.

FIG. 6 illustrates a flow diagram of a dynamic determination of migration data in accordance with embodiments of the present invention. In one embodiment, dynamic determination of migration data method 600 is performed by whitelist searcher 330 and blacklist searcher 340 of FIG. 3.

Referring to FIG. 6, block 610 searches user data on a first system based on a blacklist In one embodiment, prior to searching the user data on a first system based on a blacklist, block 610 may need to obtain the blacklist. In one embodiment, the blacklist can be obtained from a memory on the first system or the second system. In an alternate embodiment, the blacklist can be obtained from an operating system on the first system. In another alternate embodiment, block 610 can determine if a network is available and if a network is available, download the blacklist over the network.

In one embodiment, the search based on the blacklist can be performed without requiring user interaction. In one embodiment, the blacklist can identify one or more folders in the user data which may not be searched for migration data. In this embodiment, the folders listed in the blacklist can be passed over or skipped when performing the search of the user data for migration data. In one embodiment, the blacklist can identify one or more file types or file extensions. In this embodiment, any files in the user data whose file types match a file type identified in the blacklist or any files whose file extensions match a file extension identified in the blacklist may not be included in the migration data. In certain embodiments, file types can include hidden files, system files, or application files. In certain embodiments, file extensions can include .exe, .dll, .dat, .sys, Readme files, .drv, .cab, .cpl, .dmp, .cfg, .ini., and .ws. For example, if the blacklist contains the file extension “.exe” and the file type “system”, the search can exclude all files in the user data which end in “.exe” or are “system” files from the migration data. Method 600 then proceeds to block 620.

Block 620 searches system data on a first system based on a whitelist. In one embodiment, prior to searching the system data on a first system based on a whitelist, block 620 may need to obtain the whitelist. In one embodiment, the whitelist can be obtained from a memory on the first system or the second system. In an alternate embodiment, the whitelist can be obtained from an operating system on the first system. In another alternate embodiment, block 620 can determine if a network is available and if a network is available, download the whitelist over the network.

In one embodiment, the search of the system data based on the whitelist can be performed without requiring user interaction. In one embodiment, the system data can correspond to data that is stored outside of a home directory/folder or “user” directory/folder of one or more users of the first system. The searching using the whitelist can perform searches through locations (e.g., folders or subdirectories) that are outside of the user's home directory/folder. In one embodiment, the whitelist can identify one or more file types or file extensions. In one embodiment, a file located in system data can be included in migration data from a first system to a second system if the file type of the file matches a file type listed in the whitelist. In one embodiment, a file located in system data can be included in migration data from a first system to a second system if the file extension of the file matches a file extension listed in the whitelist. For example, if the whitelist contains the file extension “.doc” and the file type “Excel”, the migration data can include all files in the system data which whose file extension is “.doc” or which are “Excel” files, even if those files reside within folders identified in the blacklist.

In certain embodiments, once block 610 and block 620 have completed, method 600 further can migrate the migration data from the first system to the second system. In one embodiment, method 600 can present (e.g., display on a display device) the migration data to a user for selection. The presentation of the migration data can show information about each file or folder selected to be migrated and allow a user to select or deselect individual files or folders to include or exclude respectively from the migration data. In this embodiment, the portion of the migration data that is selected can be migrated from the first system to the second system, and the migration can occur over a network connection. In an alternate embodiment, method 600 migrates the migration data from the first system to the second system without presenting the migration data to a user for selection. Establishing the network connection and migrating the migration data is described below in conjunction with FIG. 8. Method 600 then ends.

Method 600 illustrates one implementation of dynamic determination of migration data. In alternate embodiments, the order in which the blocks of method 600 are performed can be modified without departing from the scope of the invention. In one embodiment, method 600 can search user data on a first system based on a blacklist prior to searching system data on a first system based on a whitelist. In an alternate embodiment, method 600 can search system data on a first system based on a whitelist prior to searching user data on the first system based on a blacklist.

FIG. 7 illustrates a flow diagram of an alternate dynamic determination of migration data in accordance with embodiments of the present invention. In one embodiment, dynamic determination of migration data method 700 is performed by whitelist searcher 330, blacklist searcher 340, and results presenter 350 of FIG. 3.

Referring to FIG. 7, block 710 searches data on a first system for migration data based on a whitelist. In one embodiment, prior to searching the data on a first system based on a whitelist, block 710 may need to obtain the whitelist. In one embodiment, the whitelist can be obtained from a memory on the first system or the second system. In an alternate embodiment, the whitelist can be obtained from an operating system on the first system. In another alternate embodiment, block 710 can determine if a network is available and if a network is available, download the whitelist over the network.

In one embodiment, all data on the first system can be searched based on the whitelist. In an alternate embodiment, system data and other files and folders outside of the user's home directory or “user” directory on the first system can be searched based on the whitelist. In one embodiment, the search based on the whitelist can be performed without requiring user interaction.

In one embodiment, the whitelist can identify one or more file types or file extensions. In one embodiment, a file can be included in migration data from a first system to a second system if the file type of the file matches a file type listed in the whitelist. In one embodiment, a file can be included in migration data from a first system to a second system if the file extension of the file matches a file extension listed in the whitelist. For example, if the whitelist contains the file extension “.doc” and the file type “Excel”, the migration data can include the files in the data searched whose file extension is “.doc” and all “Excel” files. Once the data has been searched based on the whitelist and migration data has been identified, method 700 proceeds to block 720.

At block 720, a determination is made as to whether the identified migration data matches information in a blacklist. In one embodiment, the identified migration data can be determined by a search of data based on the whitelist. In one embodiment, prior to making the determination, block 720 may need to obtain the blacklist. In one embodiment, the blacklist can be obtained from a memory on the first system. In an alternate embodiment, the blacklist can be obtained from an operating system on the first system. In another alternate embodiment, block 720 can determine if a network is available and if a network is available, download the blacklist over the network. The identified migration data can match information in a blacklist if a portion of the identified migration data matches a portion of information listed in the blacklist. In one embodiment, the blacklist can include one or more file types or one or more file extensions. In this embodiment, the identified migration data can match information in the blacklist if a file included in the identified migration data has a file type that matches a file type listed in the blacklist or has a file extension that matches a file extension listed in the blacklist. If the identified migration data does not match information in the blacklist, method 700 proceeds to block 740. If a portion of the identified migration data matches information in the blacklist, the process proceeds to block 730.

At block 730, the identified migration data is updated based on the blacklist. In one embodiment, the blacklist can identify one or more folders in migration data which may not be included in migration data from a first system to a second system. In this embodiment, if the identified migration data contains one or more of the folders listed in the blacklist, the identified migration data can be updated such that those folders are removed from the identified migration data. In one embodiment, the blacklist can identify one or more file types or one or more file extensions that may not be included in migration data from a first system to a second system. In this embodiment, each file in the identified migration data can be compared to the blacklist. In this embodiment, a file whose file type matches a file type listed in the blacklist or a file extension listed in the blacklist, the identified migration data can be updated such that the file is removed from the identified migration data. For example, if the identified migration data includes a proprietary screen background of the first system, and the blacklist specifically includes proprietary backgrounds of the first system, the identified migration data is updated to no longer include the proprietary screen background. Method 700 then proceeds to block 740.

Block 740 presents the migration data for selection. In one embodiment, the migration data is presented as a list of folders and files. In one embodiment, the list of folders presented can include a tab that can be clicked to list one or more files contained within the folder. In one embodiment, the migration data is presented to a user for selection. In this embodiment, the user can select a portion of the migration data to migrate from a first system to a second system. In one embodiment, upon a user's selection of a portion of the migration data, block 740 can connect the first system to the second system over a network connection and migrate the selected portion of the migration data from the first system to the second system. Establishing the network connection and migration of data from the first system to the second system is described below in conjunction with FIG. 8. Method 700 then ends.

In certain embodiments, block 740 is optional and is not performed. In certain embodiments, if block 740 is omitted, the migration data can be automatically migrated from the first system to the second system over a network connection, as described below in conjunction with FIG. 8.

FIG. 8 illustrates a flow diagram of a migration of data method in accordance with embodiments of the present invention. In one embodiment, migration of data method 800 is performed by results presenter 350 of FIG. 3.

Referring to FIG. 8, block 810 securely connects a first system and a second system over a network. In one embodiment, the first system and the second system can discover each other through a broadcast server and securely connect over the network. In one embodiment, once the first system and the second system are securely connected, information related to the secure connection can be cached in the second system. In one embodiment, the information related to the secure connection can also be cached in the first system. Method 800 then proceeds to block 820.

Block 820 sends the migration data from the first system to the second system over the secure connection. In one embodiment, the migration data can be stored as an ordered list of files. In one embodiment, the order can represent an order in which to send the files. In this embodiment, a pointer can be maintained in the list which points to the file currently being migrated. In one embodiment, if the secure connection between the first system and the second system is interrupted, the pointer may point to the file in the migration data which was being migrated when the network was interrupted. In this embodiment, upon reconnection of the first system and the second system over the network, the first system can send migration data to the second system starting with the interrupted file, as represented by the pointer. Therefore, in this embodiment, the data transmission may not have to be started from the beginning, and instead can start where the previous transmission left off. Method 800 then proceeds to block 830.

At block 830, a determination is made as to whether there was a network failure while the migration data was being sent. If there was no network failure while the migration data was sent, method 800 proceeds to block 850. If there was a network failure while the migration data was being sent, method 800 proceeds to block 840.

At block 840, a determination is made of whether a verification of a reconnection of the first system and the second system was successful. In one embodiment, prior to the determination, a reconnection between a first system and a second system must be established. In one embodiment, the reconnection can be established over a broadcast server, where the first system and the second system broadcast their availability and can connect to each other if both the first system and the second system are available. In one embodiment, the verification of the reconnection between the first system and the second system can be successful if cached information stored in the first system compares in a predetermined manner (e.g., matches) the cached information stored in the second system. In one embodiment, the cached information can include information related to the original handshake between the first system and the second system. In an alternate embodiment, the cached information can include internet protocol (IP) addresses of the first system and the second system.

In one embodiment, the cached information is stored only in the second system. In this embodiment, the second system compares the cached information with information obtained from the first system. In one embodiment, if the cached information includes an IP address of a system with which the second system had a secure connection, the second system can obtain the IP address of the first system and compare the cached IP address to the IP address of the first system. In one embodiment, if the cached IP address and the IP address of the first system compare in a predetermined manner (e.g., match), the verification of the reconnection can be successful. If the verification of the reconnection of the first system and the second system is not successful, method 800 ends. If the verification of the reconnection of the first system and the second system is successful, method 800 proceeds to block 850.

At block 850, a determination is made of whether all migration data has been sent from the first system to the second system. In one embodiment, all migration data has been sent if the pointer in the migration data points to the end of the migration data. If all of the migration data has not been sent from the first system to the second system, method 800 returns to block 820. If all of the migration data has been sent from the first system to the second system, method 800 ends.

The methods as described herein are not described with reference to any particular programming language. It will be appreciated that a variety of programming languages may be used to implement the teachings of the present invention as described herein. Furthermore, it is common in the art to speak of software, in one form or another (e.g., program, procedure, process, application, module, logic, etc.), as taking an action or causing a result. Such expressions are merely a shorthand way of saying that execution of the software by a computer causes the processor of the computer to perform an action or produce a result. It will be further appreciated that more or fewer processes may be incorporated into the methods 600, 700, and 800 in FIG. 6, FIG. 7, and FIG. 8 respectively without departing from the scope of the invention and that no particular order is implied by the arrangement of blocks shown and described herein.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

1. A computer-implemented method for dynamic determination of migration data comprising:
searching, by a data processing system, user data in a first system for migration data without requiring user interaction, wherein the searching is based on a blacklist, and wherein the blacklist comprises at least one of one or more folders which should not be searched for migration data and one or more files types which should not be included in the migration data or one or more file extensions which should not be included in the migration data; and
searching system data in the first system for migration data without requiring user interaction, wherein the searching is based on a whitelist, and wherein the whitelist comprises at least one of one or more file types or one or more file extensions.

2. The method of claim 1, further comprising:
presenting the migration data for selection, wherein selecting a portion of the migration data causes the selected portion to be migrated from the first system to a second system over a secure network connection, and wherein the searching based on the whitelist performs a search outside of the one or more folders which should not be searched for migration data.

3. The method of claim 2, further comprising:
upon reconnection of the first system to the second system after a network failure:
authenticating a reconnection of the first system to the second system using cached information associated with the secure network connection, and
migrating a remaining portion of the selected portion of the migration data, wherein the remaining portion is determined based on a sent portion of the selected portion of the migration data previously sent over the secure network connection.

4. The method of claim 1, wherein the blacklist comprises system data or system software of an operating system on the first system, wherein the operating system on the first system is different than an operating system on the second system.

5. The method of claim 1, wherein the system data comprises data that is stored outside of a home directory of one or more users of the first system, and wherein the searching based on the whitelist performs a search within the one or more folders included in the blacklist.

6. The method of claim 1, wherein
if the whitelist comprises a file type and if a file type of a file in the system data compares in a predetermined manner to the file type in the whitelist, the file is included in the migration data, and
if the whitelist comprises a file extension and if a file extension of a file in the system data compares in a predetermined manner to the file extension in the whitelist, the file is included in the migration data.

7. A computer-implemented method for dynamic determination of migration data comprising:
searching data in the first system for migration data without requiring user interaction, wherein the searching is based on a whitelist, wherein the whitelist comprises at least one of one or more file types and one or more file extensions;
searching the migration data based on a blacklist, wherein the blacklist removes data from the migration data which compares in a predetermined manner with the blacklist; and
presenting the migration data for selection, wherein selecting a portion of the migration data causes the selected portion to be migrated from the first system to a second system over a secure network connection.

8. The method of claim 7, further comprising:
upon reconnection of the first system to the second system after a network failure:
authenticating a reconnection of the first system to the second system using cached information associated with the secure network connection, and
migrating a remaining portion of the selected portion of the migration data, wherein the remaining portion is determined based on a sent portion of the selected portion of the migration data previously sent over the secure network connection.

9. The method of claim 7, wherein
if the whitelist comprises a file type and if a file type of a file in the data compares in a predetermined manner to the file type in the whitelist, the file is included in the migration data, and
if the whitelist comprises a file extension and if a file extension of a file in the data compares in a predetermined manner to the file extension in the whitelist, the file is included in the migration data.

10. The method of claim 7, wherein the blacklist comprises data of an operating system on the first system that should not be migrated to the second system, wherein the blacklist comprises at least one of one or more folders to remove from the migration data, one or more file types to remove from the migration data, and one or more file extensions to remove from the migration data.

11. A computer-readable storage medium comprising executable instructions to cause a processor to perform operations for dynamic determination of migration data, the instructions comprising:
searching, by a data processing system, user data in a first system for migration data without requiring user interaction, wherein the searching is based on a blacklist, and wherein the blacklist comprises at least one of one or more folders which should not be searched for migration data and one or more files types which should not be included in the migration data or one or more file extensions which should not be included in the migration data; and
searching system data in the first system for migration data without requiring user interaction, wherein the searching is based on a whitelist, and wherein the whitelist comprises at least one of one or more file types or one or more file extensions.

12. The computer-readable storage medium of claim 11, wherein the instructions further comprise:
presenting the migration data for selection, wherein selecting a portion of the migration data causes the selected portion to be migrated from the first system to a second system over a secure network connection, and wherein the searching based on the whitelist performs a search outside of the one or more folders which should not be searched for migration data.

13. The computer-readable storage medium of claim 11, wherein the instructions further comprise:
upon reconnection of the first system to the second system after a network failure:
authenticating a reconnection of the first system to the second system using cached information associated with the secure network connection, and
migrating a remaining portion of the selected portion of the migration data, wherein the remaining portion is determined based on a sent portion of the selected portion of the migration data previously sent over the secure network connection.

14. The computer-readable storage medium of claim 11, wherein the blacklist comprises system data or system software of an operating system on the first system, wherein the operating system on the first system is different than an operating system on the second system.

15. The computer-readable storage medium of claim 11, wherein the system data comprises data that is stored outside of a home directory of one or more users of the first system, and wherein the searching based on the whitelist performs a search within the one or more folders included in the blacklist.

16. The computer-readable storage medium of claim 11, wherein
if the whitelist comprises a file type and if a file type of a file in the system data compares in a predetermined manner to the file type in the whitelist, the file is included in the migration data, and
if the whitelist comprises a file extension and if a file extension of a file in the system data compares in a predetermined manner to the file extension in the whitelist, the file is included in the migration data.

17. A computer-readable storage medium comprising executable instructions to cause a processor to perform operations for dynamic determination of migration data, the instructions comprising:
searching data in the first system for migration data without requiring user interaction, wherein the searching is based on a whitelist, wherein the whitelist comprises at least one of one or more file types and one or more file extensions;
searching the migration data based on a blacklist, wherein the blacklist removes data from the migration data which compares in a predetermined manner with the blacklist; and
presenting the migration data for selection, wherein selecting a portion of the migration data causes the selected portion to be migrated from the first system to a second system over a secure network connection.

18. The computer-readable storage medium of claim 17, wherein the instructions further comprise:
upon reconnection of the first system to the second system after a network failure:
authenticating a reconnection of the first system to the second system using cached information associated with the secure network connection, and
migrating a remaining portion of the selected portion of the migration data, wherein the remaining portion is determined based on a sent portion of the selected portion of the migration data previously sent over the secure network connection.

19. The computer-readable storage medium of claim 17, wherein the instructions further comprise:
if the whitelist comprises a file type and if a file type of a file in the data compares in a predetermined manner to the file type in the whitelist, the file is included in the migration data, and
if the whitelist comprises a file extension and if a file extension of a file in the data compares in a predetermined manner to the file extension in the whitelist, the file is included in the migration data.

20. The computer-readable storage medium of claim 17, wherein the blacklist comprises data of an operating system on the first system that should not be migrated to the second system, wherein the blacklist comprises at least one of one or more folders to remove from the migration data, one or more file types to remove from the migration data, and one or more file extensions to remove from the migration data.

21. An apparatus comprising:
means for searching, by a data processing system, user data in a first system for migration data without requiring user interaction, wherein the searching is based on a blacklist, and wherein the blacklist comprises at least one of one or more folders which should not be searched for migration data and one or more files types which should not be included in the migration data or one or more file extensions which should not be included in the migration data; and
means for searching system data in the first system for migration data without requiring user interaction, wherein the searching is based on a whitelist, and wherein the whitelist comprises at least one of one or more file types or one or more file extensions.

22. An apparatus comprising:
means for searching data in the first system for migration data without requiring user interaction, wherein the searching is based on a whitelist, wherein the whitelist comprises at least one of one or more file types and one or more file extensions;
means for searching the migration data based on a blacklist, wherein the blacklist removes data from the migration data which compares in a predetermined manner with the blacklist; and
means for presenting the migration data for selection, wherein selecting a portion of the migration data causes the selected portion to be migrated from the first system to a second system over a secure network connection.

23. A computer system comprising:
a memory; and
a processor configurable by instructions stored in the memory to:
search, by a data processing system, user data in a first system for migration data without requiring user interaction, wherein the searching is based on a blacklist, and wherein the blacklist comprises at least one of one or more folders which should not be searched for migration data and one or more files types which should not be included in the migration data or one or more file extensions which should not be included in the migration data; and
search system data in the first system for migration data without requiring user interaction, wherein the searching is based on a whitelist, and wherein the whitelist comprises at least one of one or more file types or one or more file extensions.

24. A computer system comprising:
a memory; and
a processor configurable by instructions stored in the memory to:
search data in the first system for migration data without requiring user interaction, wherein the searching is based on a whitelist, wherein the whitelist comprises at least one of one or more file types and one or more file extensions;
search the migration data based on a blacklist, wherein the blacklist removes data from the migration data which compares in a predetermined manner with the blacklist; and
present the migration data for selection, wherein selecting a portion of the migration data causes the selected portion to be migrated from the first system to a second system over a secure network connection.
